(19) United States
(12) Patent Application Publication
(10) Pub. No.: US 2002/0013673 A1
(43) Pub. Date: Jan. 31, 2002

(54) Electrical device having at least one two-terminal network

(76) Inventor: Hanspeter Muhlemann, Aesch (CH)

Correspondence Address: Ralph W. Selitto, Jr., P.O. Box 1477, Edison, NJ, 08818-1477, US

(21) Appl. No.: 09/819,418

(22) Filed: Mar. 28, 2001

(30) Foreign Application Priority Data
Mar. 30, 2000 (CH) 612/00

(51) Int. Cl. G06F 19/00

(52) U.S. Cl. 702/107

(57) ABSTRACT

An electrical device has one two-terminal network and a measuring device (4) and a source (3) which are connected to the two-terminal network. The measuring device (4) controls the source (3) via a computing device (5) in such a way that a desired relationship is produced between current and voltage of the two-terminal network.

### TECHNICAL FIELD

Electrical devices having two-terminal networks are used in many fields of electrical engineering. In particular, for example a measuring unit which measures an electrical voltage is a two-terminal network. Another application of an electrical device having two-terminal networks is, for example, a heating regulator which, equipped with a plurality of temperature sensors, switches one or a plurality of radiators on and off via relays.

### PRIOR ART

The patent specification DE 4334994 discloses transmitting analog signals via an analog-to-digital converter to a computer and analyzing them further there. Usually, attempts are made to the effect that the quantity to be measured is influenced as little as possible by a measuring device. This is evident from the fact that, for example, the highest possible input resistances are sought in the case of voltage measuring units and the lowest possible input resistances are sought in the case of current measuring units.

### SUMMARY OF THE INVENTION

In the case of the electrical device having at least one two-terminal network according to the invention, a measuring device and a controllable source are connected to a two-terminal network, the measurement result of the measuring device controlling the source via a computing device in such a way that a relationship is produced between the voltage and the current of the two-terminal network. In accordance with a further embodiment of the invention, the measurement result is digitized and, if a digital computing device is provided, the result thereof is converted into an analog quantity for the source.

Many components appertaining to electrical engineering and electronics are distinguished by specific relationships between applied voltages and the currents flowing, which are described in the data sheets that are available for them. These dependencies may also comprise, for example, time integrals as in the case of capacitors. The invention allows such components to be artificially simulated. Furthermore, the subject matter of the invention allows the formation of components which do not normally arise in electronics; a negative resistance or a negative inductance, for instance, might be enumerated as an example; components having nonlinear dependencies between the currents and voltages can also be realized. The properties of the components generated artificially by the subject matter of the invention are principally dependent on the computing specification used to produce the relationship between currents and voltages; the consequence of this is that the properties of the components can be transferred by simple exchange of information. It is a further advantage of the invention that, as a result, existing components such as transistors, for example, can also be analyzed and simulated using the information obtained.

### ENUMERATION OF THE DRAWINGS

FIG. 1 shows a circuit diagram of a first embodiment of an electrical device according to the invention.

FIG. 2 shows a circuit diagram of a second embodiment of an electrical device according to the invention.

FIG. 3 shows a circuit diagram of a third embodiment of an electrical device according to the invention.

### EXPLANATION OF THE INVENTION

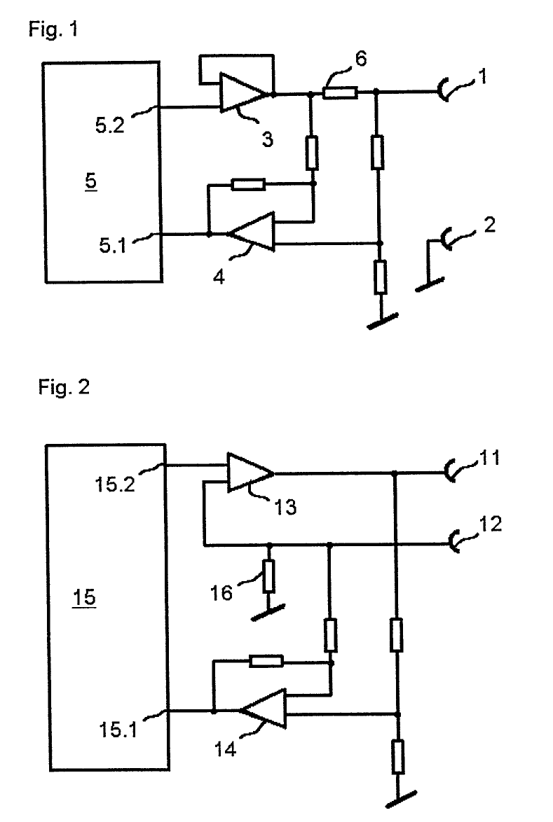

FIG. 1 illustrates a circuit diagram of a first embodiment of an electrical device according to the invention. The first terminal of a two-terminal network of the device is designated by 1 and the second terminal by 2. Furthermore, FIG. 1 shows a first and a second operational amplifier, designated by 3 and 4, a computing device designated by 5 and a shunt resistor 6. The computing device 5 has a voltage input 5.1 and a voltage output 5.2. The first operational amplifier 3 is connected as a voltage follower in a manner known per se, the input of which is connected to the voltage output 5.2 of the computing device 5. The output of the first operational amplifier 3 is connected via the shunt resistor 6 to the first terminal 1 of the two-terminal network. The second operational amplifier 4 is connected as a differential amplifier with a further four resistors in a manner known per se. The voltage across the shunt resistor 6 serves as the input voltage of the differential amplifier. The output of the second operational amplifier 4 is connected to the voltage input 5.1 of the computing device 5. In this example, the second terminal 2 of the two-terminal network is at the reference-ground potential of the two-terminal network, where the reference-ground potential of the two-terminal network may be different from the reference-ground potentials of further two-terminal networks of the device and the electrical network outside the two-terminal network.

If a voltage which is not equal to the output voltage of the first operational amplifier 3 is present between the terminals 1 and 2 of the two-terminal network of the device according to FIG. 1, then a current flows through the shunt resistor 6 and generates a voltage drop across the shunt resistor 6. The voltage drop across the shunt resistor 6 is converted by the second operational amplifier 4 into a voltage relative to the reference-ground potential and applied to the voltage input 5.1 of the computing device 5. The computing device 5 determines from this, in accordance with a computing algorithm, a voltage which is applied to the voltage output 5.2. The voltage output 5.2 thus influences the first operational amplifier 3, whose output voltage changes, thereby altering the current through the shunt resistor 6.

If the computing algorithm is chosen in a suitable manner, an equilibrium is established between the electrical network situated outside the two-terminal network and the two-terminal network of the device.

Given ideal dimensioning of the components in the two-terminal network of the device according to FIG. 1, the current through the shunt resistor 6 is almost equal to the current through the terminals 1 and 2 of the two-terminal network, and the output voltage of the first operational amplifier is almost equal to the voltage between the terminals 1 and 2 of the two-terminal network. With real dimensioning, there are systematic deviations from the ideal values, which can be taken into account in the computing algorithm of the computing device 5.

FIG. 2 illustrates a circuit diagram of a second embodiment of an electrical device according to the invention. The first and second terminals of a two-terminal network of the device are designated by 11 and 12. Furthermore, FIG. 2 shows a first operational amplifier designated by 13 and a second operational amplifier designated by 14 and also a computing device 15 and a shunt resistor 16. The computing device 15 has a voltage input 15.1 and a voltage output 15.2. The first operational amplifier 13 is connected together with the shunt resistor 16 as a current source in a manner known per se. The output of the first operational amplifier 13 is connected to the first terminal 11 of the two-terminal network, while the second terminal 12 of the two-terminal network is connected to one input of the first operational amplifier 13 and one end of the shunt resistor 16. The other end of the shunt resistor 16 is at the reference-ground potential of the two-terminal network. The second input of the first operational amplifier 13 is connected to the voltage output 15.2 of the computing device 15. The second operational amplifier 14 is connected as a differential amplifier with four further resistors in a manner known per se, the voltage difference between the two terminals 11, 12 of the two-terminal network serving as the input voltage of the differential amplifier. The output of the second operational amplifier is connected to the voltage input 15.1 of the computing device 15.

If the device according to FIG. 2 is connected into an external network, then a current flows through the terminals 11, 12 of the two-terminal network, which current is predetermined by the value of the voltage at the voltage output 15.2 of the computing device, and a voltage is established between the terminals 11, 12 of the two-terminal network. This voltage is measured by the second operational amplifier 14 and applied to the voltage input 15.1 of the computing device 15, which determines a value from this in accordance with a computing algorithm and applies the result to the voltage output 15.2.

With a suitable choice of computing algorithm, an equilibrium is established between the electrical network which is situated outside the two-terminal network and the two-terminal network of the device.

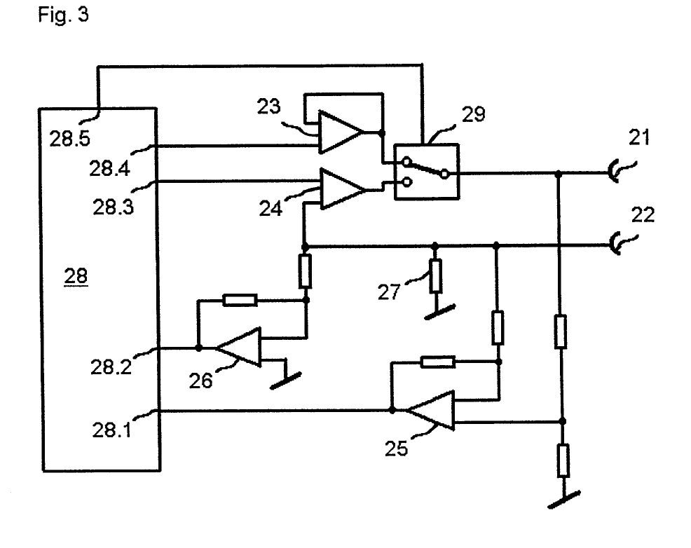

FIG. 3 illustrates a circuit diagram of a third embodiment of an electrical device according to the invention. The first terminal of a two-terminal network of the device is designated by 21, and the second terminal by 22. In FIG. 3, a first, second, third and fourth operational amplifier are designated by 23, 24, 25 and 26. Furthermore, FIG. 3 shows a shunt resistor 27, a computing device 28 and a switch 29. The computing device 28 has a first voltage input 28.1, a second voltage input 28.2, a first voltage output 28.3, a second voltage output 28.4 and a switching output 28.5. The first operational amplifier 23 is connected as a voltage follower in a manner known per se, whose input is connected to the second voltage output 28.4 of the computing device 28 and whose output is connected to the switch 29. Together with the shunt resistor 27 connected relative to the reference-ground potential of the two-terminal network, the second operational amplifier 24 forms a current source in a manner known per se, the input thereof being connected to the first voltage output 28.3 of the computing device 28 and its output being connected to the switch 29. The third operational amplifier 25 is connected as a differential amplifier with four further resistors in a manner known per se. The voltage between the terminals 21, 22 of the two-terminal network serves as the input voltage for the differential amplifier 25. The output of the third operational amplifier 25 is connected to the first voltage input 28.1 of the computing device 28. The fourth operational amplifier 26 is connected as an inverting amplifier with two further resistors in a manner known per se, the input of which amplifier picks off the voltage across the shunt resistor 27 and the output of which amplifier is connected to the second voltage input 28.2 of the computing device 28. The first terminal 21 of the two-terminal network is connected to the switch 29 and the second terminal 22 is connected to the shunt resistor 27. The switching output 28.5 of the computing device 28 is connected to the switch 29.

If the terminals 21, 22 of the two-terminal network of the device according to FIG. 3 are connected to an external network, then an electrical voltage appears between the terminals 21, 22 of the two-terminal network and a current flows through the terminals 21, 22. The third operational amplifier 25 measures the voltage and applies a proportional value to the first voltage input 28.1 of the computing device 28. The current flowing through the terminals 21, 22 generates a voltage drop across the shunt resistor 27, which voltage drop is measured by the fourth operational amplifier 26 and is applied to the second voltage input 28.2 of the computing device 28. Consequently, the computing device 28 knows the current and the voltage of the two-terminal network. The computing device 28 determines therefrom a value for controlling the current source 24, and it outputs said value by means of an electrical voltage to the first voltage output 28.3; furthermore, the computing device 28 determines a value for controlling the voltage source 23, and it applies said value to the second voltage output 28.4. With the switching output 28.5 of the computing device 28, the computing device 28 chooses, via the switch 29, whether the current source 24 or the voltage source 23 is connected to the first terminal 21 of the two-terminal network.

With a suitable choice of computing algorithm in the computing device 28, a desired relationship is thus produced between current and voltage of the two-terminal network, and the computing device 28 can choose either current control or voltage control via the switch 29 depending on the position in the current-voltage dependence.

During the production of the device according to the invention, the deviations from the desired values of the components used can be measured and used as additional parameters for the computing device 5, 15, 28 in order to compensate the manufacturing tolerances. This is advantageous particularly when the computing device can access a nonvolatile memory in which the additional parameters can be stored.

It is also possible to provide reference two-terminal networks with which a user can check the device. This is advantageous in particular when the user has doubts about the functional capability of his device.

The exemplary embodiments of the invention which are illustrated in FIGS. 1 to 3 use voltage inputs 5.1, 15.1, 28.1, 28.2 and voltage outputs 5.2, 15.2, 28.3, 28.4 at the computing devices 5, 15, 28; the same result can also be achieved with current inputs and/or current outputs.

If a computer is used as the computing device 5, 15, 28, the computer also allows a graphical representation of the analysis results of an external network analyzed using the device according to the invention, and also a graphical design of the electrical component to be generated by means of the invention. The properties of such a component can be transferred by simple information transfer.

1. An electrical device having at least one two-terminal network, characterized in that a measuring device (4, 14, 25, 26) and a controllable source (3, 13, 23, 24) are connected to a two-terminal network, the measurement result of the measuring device (4, 14, 25, 26) controlling the source (3, 13, 23, 24) via a computing device (5, 15, 28) in such a way that a relationship is produced between the voltage and the current of the two-terminal network.

2. A device according to claim 1, characterized in that measuring devices (4, 14, 25, 26) and sources (3, 13, 23, 24) are connected to a plurality of two-terminal networks, the measurement results of the measuring devices (4, 14, 25, 26) being controlled via one or more computing devices (5, 15, 28) in such a way that relationships are produced between the currents and the voltages of the two-terminal networks, the relationships of different two-terminal networks being able to influence one another.

3. A device according to claim 1 or 2, characterized in that the measurement result of the measuring device (4, 14, 25, 26) is digitized, the computing device (5, 15, 28) operates digitally and the result thereof is converted into an analog quantity for the source (3, 13, 23, 24).

4. A device according to claim 3, characterized in that a microprocessor device with a programmable nonvolatile memory is used as the computing device (5, 15, 28).

5. A device according to claim 1 or 2, characterized in that current measuring devices (4, 26) and/or voltage measuring devices (14, 25) are provided as the measuring devices and voltage sources (3, 23) and/or current sources (13, 24) are provided as the sources.

6. A device according to claim 5, characterized in that the computing devices (28) have switching outputs (28.5) and electrically controllable switches (29) are provided, by means of which the computing devices (28) can change over between current sources (24) and voltage sources (23).
